(19) United States
(12) Patent Application Publication
(10) Pub. No.: US 2014/0294214 A1
(43) Pub. Date: Oct. 2, 2014

(54) DIGITAL HEARING AID

(71) Applicant: JIANGSU BETTERLIFE MEDICAL CO., LTD, Changshu (CN)

(72) Inventors: Yong David Zhao, Changshu (CN); Jinping Jennifer Zhao, Changshu (CN)

(73) Assignee: JAINGSU BETTERLIFE MEDICAL CO., LTD

(21) Appl. No.: 14/301,347

(22) Filed: Jun. 11, 2014

Related U.S. Application Data
(63) Continuation of application No. PCT/CN2012/000172, filed on Feb. 13, 2012.

(30) Foreign Application Priority Data
Dec. 16, 2011 (CN) 201110421118.8

(51) Int. Cl. H04R 25/00

(52) U.S. Cl. CPC H04R 25/65
USPC 381/330

(57) ABSTRACT

A digital hearing aid is disclosed in the present disclosure. The digital hearing aid comprises a body hung behind an ear and a sound transmitting device for receiving and outputting sound that is placed within an auricle and extends into an external auditory canal. The body and the sound transmitting device are connected and fixed together via a connecting device. The connecting device is formed of a material and a structure which are bendable, extendable and capable of maintaining the bending deformation, and the connecting device is preformed into a shape of an ear hook. In this way, the present disclosure can have the advantages of both the behind-the-ear hearing aid and the complete-in-canal hearing aid and is adaptive to the shape of the auricle and the facial structure so as to meet the demands of people in different growth stages or of different people.

### CROSS-REFERENCE TO RELATED APPLICATIONS

This present application is a Continuation Application of PCT application No. PCT/CN2012/000172 filed on Feb. 13, 2012, which claims the benefit of Chinese Patent Application No. 201110421118.8 filed on Dec. 16, 2011; the contents of which are hereby incorporated by reference.

### FIELD OF THE INVENTION

The present disclosure generally relates to the technical field of hearing aids, and more particularly, to a digital hearing aid.

### BACKGROUND OF THE INVENTION

Most of hearing aids currently available on the market are behind-the-ear hearing aids BTE and complete-in-canal hearing aids CIC. However, the behind-the-ear hearing aids BTE cannot make full use of acoustical advantages (e.g., acoustic wave amplification as well as the stereo effect and the sound directivity) of the helix, the auricle, and the auditory canal of a human body because the microphone thereof is put behind the ear. For the complete-in-canal hearing aids CIC, they cannot satisfy demands for large power or large-capacity batteries because they are limited by the narrow space inside the auditory canal; howling and sound feedback may be caused because the sound pressure cannot be well maintained due to the complex physiological structure of the auditory canal; and the user may feel uncomfortable because of the sense of canal blockage when wearing a complete-in-canal hearing aid CIC.

The hearing impairment degree of patients with hearing problems varies greatly. Because personalized programming and fitting are time consuming, it is difficult for the current hearing aid products to satisfy the demands for intensive services within a short period during the large-scale biding and purchasing by the Disabled Persons Federation (DPF) and the Bureau of Retired Veteran Cadres (BRVC) or the like. Moreover, the hearing aid products are unsuitable for online sale and mail orders because it is difficult to provide personalized fitting services in this way. Especially, children with hearing problems need to wear hearing aids of different sizes as their body grows, and the patients with hearing problems are of different builds and different auditory canal structures, so hearing aids of only one size or three different sizes (i.e., large, medium and small sizes) cannot meet the demands of the market. Accordingly, a new integrated product having the merits of both the behind-the-ear hearing aid and the complete-in-canal hearing aid is needed in the market.

### SUMMARY OF THE INVENTION

A main technical problem to be solved by the present disclosure is to provide a digital hearing aid, which has the advantages of both the behind-the-ear hearing aid and the complete-in-canal hearing aid and is adaptive to the shape of the auricle and the facial structure so as to meet the demands of people in different growth stages or of different people.

To solve the aforesaid technical problem, one technical solution adopted by the present disclosure is to provide a digital hearing aid. The digital hearing aid comprises a body hung behind an ear and a sound transmitting device for receiving and outputting sound that is placed within an auricle and extends into an external auditory canal, the body and the sound transmitting device are connected and fixed together via a connecting device, the connecting device is formed of a material and a structure which are bendable, extendable and capable of maintaining the bending deformation, the connecting device is preformed into a shape of an ear hook, and the sound transmitting device comprises a sound device shell having a microphone and a receiver built therein.

The connecting device comprises a conduit with conductive wires inserted therethrough and a sleeve disposed outside the conduit, and the length of the conduit can be varied by means of inserting the conduit into or pulling the conduit out of the body; winding the conduit into or out of the sleeve and fixing the conduit; inserting the conduit into or pulling the conduit out of the sound device shell and fixing the conduit; and winding the conduit into a coil which is stretchable and retractable along a length direction.

Preferably, the body is of a unitary or non-unitary structure, a receiving cavity and a battery chamber are provided within the body, a chip and a circuit device are installed within the receiving cavity, a battery cover is disposed correspondingly at an opening of the battery chamber, batteries are installed within the battery chamber, and a program shifter, a standby microphone or other circuit interfaces or programming line sockets and a volume button are provided on a side surface of the body, and wherein the program shifter is a program shifter having no less than one preset program or listening environment and compatible with manual selection and machine programming, the volume button is a rolling or rotary button for adjusting the volume manually, and the preset program is shifted via the program shifter or by pressing the volume button.

More preferably, the sound transmitting device further comprises a soft jacket which is open at one end, the sound device shell is disposed within the soft jacket, a hearing tube that can be bent arbitrarily is disposed to extend from a front end of the soft jacket, a soft ear mold is disposed fitted over the hearing tube, the other end of the soft jacket opposite to the hearing tube is provided with a pulling-out line, and the surface of the pulling-out line has a plurality of non-smooth nicks thereon or is roughened.

More preferably, one end of the conduit is connected with the circuit device within the body, and the other end of the conduit is connected with the microphone and the receiver.

More preferably, the body is in a streamlined form with the width and the thickness thereof increasing gradually from a small tip portion to a big bottom portion, and a wireless receiver and a wireless transmitter for frequency-shift FM, Bluetooth, or communications between the left ear and the right ear, flashing light devices, and wireless locating or measuring transducers are installed within the receiving cavity of the body.

More preferably, a front and a back outside surface of the body are formed with a plurality of linear or nonlinear shallow grooves.

More preferably, an edge of the opening of the soft jacket is crimped inwardly to form an envelope, the sound device shell is put into the soft jacket from the opening and encased by the envelope of the soft jacket, pins are provided to fix the sound device shell and the soft jacket together, and the soft jacket and the sound device shell are detachable or undetachable from each other.

More preferably, a pressing and sealing device is provided between one end of the conduit and the body, the other end of the conduit is connected with the sound device shell, a plurality of conductive wires are disposed within the conduit, each of the wires is covered with an electrically insulative layer, the microphone is connected with the circuit device via one of the conductive wires, the circuit device is connected with the receiver via another one of the conductive wires, the sleeve disposed outside the conduit is movable on the conduit, metal or nonmetal wires which are bendable and can maintain the bending deformation are provided within a wall of the sleeve, an end of the conduit outside the sleeve can be winded into a spiral shape, the length of the sleeve is less than or equal to the length of the conduit, and the sleeve is a radially enclosed or radially open circular or non-circular sleeve disposed on the conduit.

More preferably, the soft ear mold comprises a fixed tube and a mold head, the hearing tube is inserted and fixed into the fixed tube, the mold head is a hemline structure tapering from the bottom to the top and made of an elastic material, a vent hole is provided on a sidewall of the mold head, an end of the mold head is provided with an earwax protective screen and a sound outlet that communicate with the hearing tube, and the mold head is a one-piece or multi-piece hemline structure.

More preferably, at least one of the two ends of the conduit is provided with a reserved end, the reserved end is disposed within the body and fixed by the pressing and sealing device, and the reserved end may also be disposed within the sound device shell.

The present disclosure has the following benefits: the digital hearing aid of the present disclosure provides a new hearing aid product for the market, which can satisfy the general hearing compensation demands by allowing about 60% of patients with hearing problems to tune the typical hearing compensation modes (or prescription formulas) preset in the product through simple operations on their own and, meanwhile, allows professional practitioners to make personalized precise programming and fitting (including a programming operating platform of open digital signal channel numbers disposed for special demands such as different acoustic qualities and special hearing impairment) for the rest 40% of the patients with hearing problems.

### BRIEF DESCRIPTION OF THE DRAWINGS

FIG. 1 is an exploded view of a preferred embodiment of a digital hearing aid according to the present disclosure;

FIG. 2 is a schematic structural view of a housing of the digital hearing aid of the present disclosure;

FIG. 3 is an exploded view of a sound transmitting device of the digital hearing aid of the present disclosure;

FIG. 4 is a schematic structural view of a connecting device of the digital hearing aid of the present disclosure;

FIG. 5 is a schematic structural view of a first embodiment of a soft ear mold of the digital hearing aid according to the present disclosure;

FIG. 6 is a schematic structural view of a second embodiment of the soft ear mold of the digital hearing aid according to the present disclosure;

FIG. 7 is a schematic structural view of a third embodiment of the soft ear mold of the digital hearing aid according to the present disclosure; and

FIG. 8 is a schematic structural view of a fourth embodiment of the soft ear mold of the digital hearing aid according to the present disclosure.

### DETAILED DESCRIPTION OF THE INVENTION

Hereinafter, preferred embodiments of the present disclosure will be described in detail with reference to the attached drawings so that the advantages and features of the present disclosure can be more readily appreciated by those skilled in the art and the claimed scope of the present disclosure can be defined more clearly.

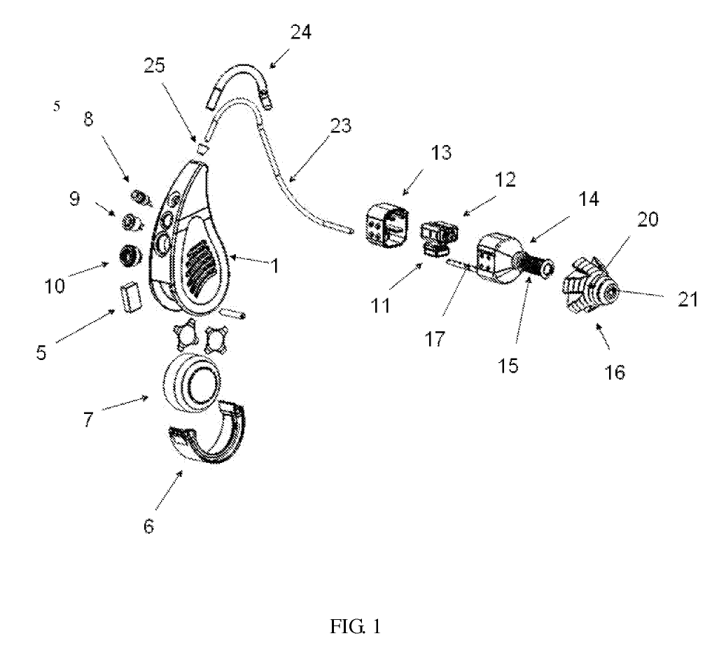

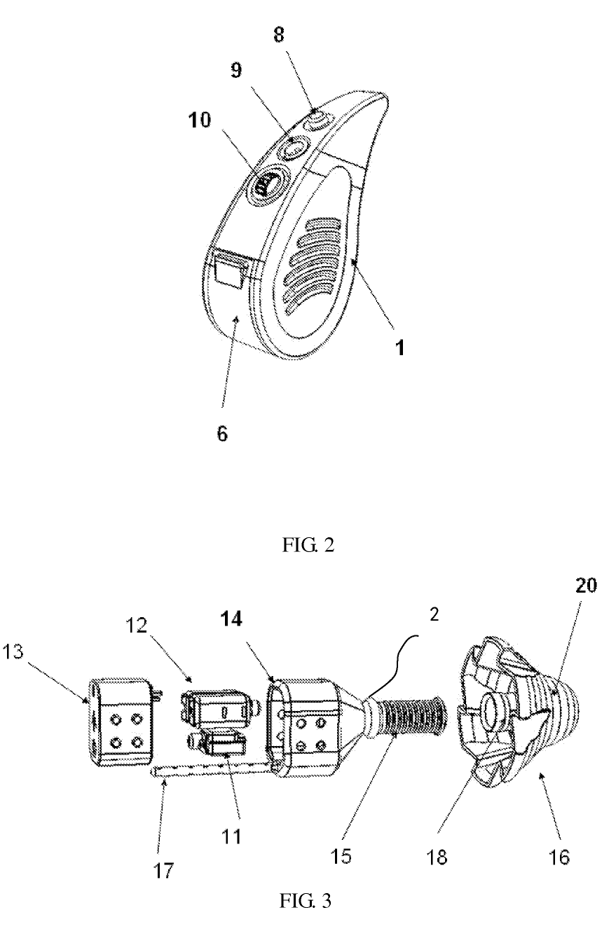

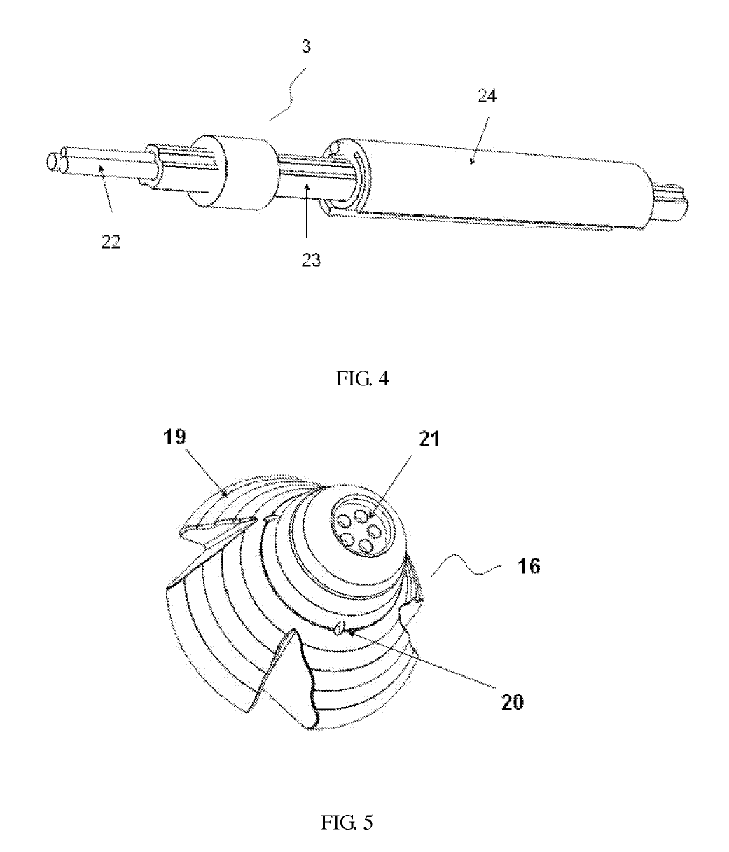

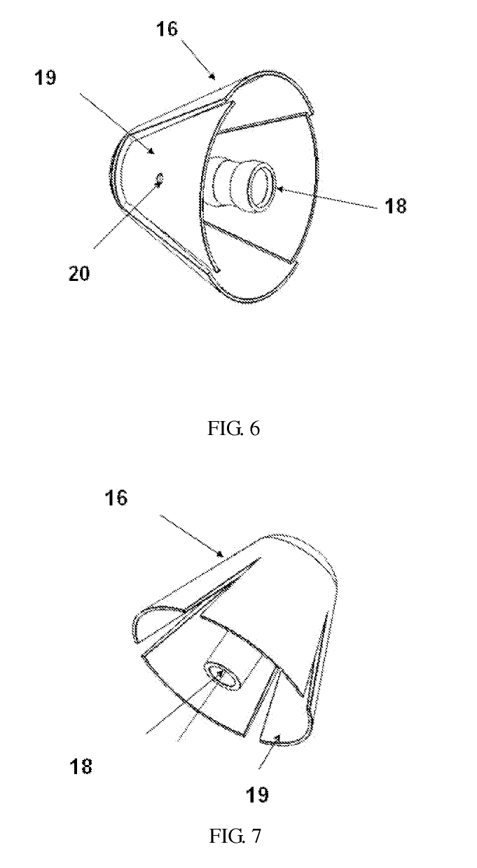

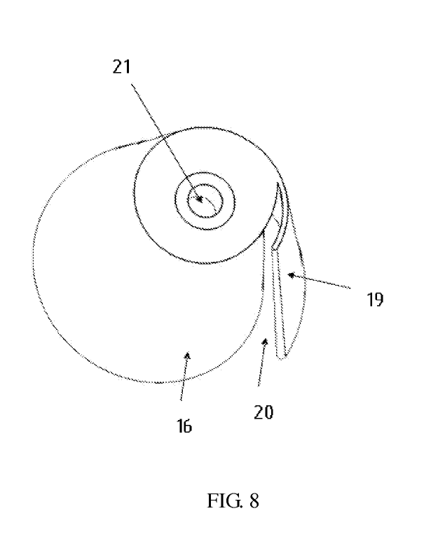

Referring to FIG. 1 to FIG. 8 together, an embodiment of the present disclosure comprises:

A digital hearing aid is provided, the digital hearing aid comprises a body 1 hung behind an ear and a sound transmitting device 2 for receiving and outputting sound that is placed within an auricle and extends into an external auditory canal, the body 1 and the sound transmitting device 2 are connected and fixed together via a connecting device 3, the connecting device 3 is preformed into a shape of an ear hook.

The first part is the body 1 hung behind the ear, a receiving cavity and a battery chamber 4 are provided within the body 1, a chip and a circuit device 5 are installed within the receiving cavity, a battery cover 6 is disposed correspondingly at an opening of the battery chamber 4, batteries 7 are installed within the battery chamber 4, and a program shifter 8, a standby microphone or other circuit interfaces or programming line sockets 9 and a volume button 10 are provided on a side surface of the body 1. The body 1 is in a streamlined form with the width and the thickness thereof increasing gradually from a small tip portion to a big bottom portion, and a wireless receiver and a wireless transmitter for frequency-shift FM, Bluetooth, or communications between the left ear and the right ear, flashing light devices, and wireless locating or measuring transducers are installed within the receiving cavity of the body 1.

According to the above descriptions, the body 1 is of a unitary or non-unitary structure, and the size of the outside surface thereof is no more than 40 mm length×30 mm width×15 mm thickness. In a typical application, a hearing aid body equipped with a 657 type large-capacity battery has a volume of about 900 mm³; the chip and the circuit device 5 are digital signal processors DSP or chips; the batteries 7 are batteries of various types from 10A to 657, and various volume sizes and rated current values; the program shifter 8 is a program shifter having no less than one preset program or listening environment and compatible with manual selection and machine programming; the volume button 10 is a rolling or rotary button for adjusting the volume manually, and the preset program can also be shifted by pressing the volume button; and these batteries 7 and parts are respectively connected with the digital signal processor circuit electrically and mechanically.

The second part is the sound transmitting device 2 for receiving and outputting sound that can be placed within an auricle and extend into an external auditory canal. The sound transmitting device 2 comprises a sound device shell 13 having a microphone 11, one or more receivers 12 or loudspeakers and a flashing light switch sensor built therein. The sound transmitting device further comprises a soft jacket 14 which is open at one end, an edge of the opening of the soft jacket 14 is crimped inwardly to form an envelope, the sound device shell 13 is put into the soft jacket 14 from the opening and encased by the envelope of the soft jacket 14, and pins are provided to fix the sound device shell 13 and the soft jacket 14 together. A hearing tube 15 is connected with a front end of the soft jacket 14, a soft ear mold 16 is disposed fitted over the hearing tube 15, and the other end of the soft jacket 14 opposite to the hearing tube 15 is provided with a pulling-out line 17.

According to the above descriptions, the microphone 11 and the receiver 12 are fixed within the sound device shell 13 having a size of no more than 25 mm height×20 mm width×15 mm thickness and a wall thickness of no more than 2 mm. The material of the sound device shell 13 may be one or more of ABS Acrylonitrile Butadiene Styrene, PP polypropylene, PE polyethylene, PC Polycarbonate or a PC/ABS polymer.

The sound device shell 13 and the soft jacket 14 which has a wall thickness of no more than 2 mm are fixed to form a detachable unitary structure by means of pins provided therebetween and the opening of the soft jacket which has a crimped edge having a smaller size than the outside surface of the shell. The material of the soft jacket 14 is one or more of silicone rubber Nusil Med 4930, polyurethane, TPU rubber, TPE, or a polymer of silicone rubber and polyurethane. The outline of the sound device shell 13 and the soft jacket 14 conforms to the auricle, so the sound device shell 13 and the soft jacket 14 can be placed within the auricle. The sound device shell 13 and the soft jacket 14 can be fixed together either via pins plus detachable mechanical interference fit, or via undetachable adhesive bonding or overmolding. The other end of the soft jacket opposite to the hearing tube 15 is provided with the pulling-out line 17, and the surface of the pulling-out line 17 has a plurality of non-smooth nicks thereon or is roughened so that it can be pulled out of the ear easily. The hearing tube 15, which has a length ranging between 5 mm and 20 mm, an outside diameter ranging between 2 mm and 5 mm and a wall thickness of no more than 2 mm, is an extension of the soft jacket 14. A liner tube, which has a wall thickness of no more than 1 mm and an inside diameter within ±0.2 mm of the inside diameter of the hearing tube 14, may be provided inside the hearing tube 14 depending on the hearing signal gain loss and practical demands on structural bending rigidity. The material of the liner tube is one or more of silicone rubber Nusil Med 4930, polyurethane, TPU rubber, TPE, or a polymer of silicone rubber and polyurethane. The material of the liner tube may be the same as or different from that of the hearing tube 14. The neck portion and the body of the soft hearing tube 14 can be bent arbitrarily so that the hearing tube 14 can be easily put into the auditory canal having a complex physiological structure and a three-dimensional curved shape.

The soft ear mold 16 is disposed fitted over the hearing tube 14. The soft ear mold 16 comprises a fixed tube 18 and a mold head 19, the hearing tube 14 is inserted and fixed into the fixed tube 18, the mold head 19 is a hemline structure tapering from the bottom to the top and made of an elastic material, a vent hole 20 is provided on a sidewall of the mold head 19, an upper end of the mold head 19 is provided with an earwax protective screen and a sound outlet 21 that communicate with the hearing tube 14. The earwax protective screen and the hearing tube may be integrally formed or separately formed and then assembled together. The hemline structure is a one-piece or multi-piece structure. The outside diameter of the upper thin head of the mold head 19 is no more 5 mm, the diameter of the lower thick head of the mold head 19 is between 3 mm and 20 mm, and the thickness of the hemline is no more than 2 mm. The material of the soft ear mold 16 is one or more of silicone rubber Nusil Med 4930, polyurethane, TPU rubber, TPE, or a polymer of silicone rubber and polyurethane. The soft ear mold 16 is used to fix the hearing tube 14 and to seal the sound pressure between the hearing tube 14 and the wall of the auditory canal while still keeping proper ventilation.

The third part is the connecting device 3 for electrically and mechanically connecting the first part with the second part. The connecting device comprises a conduit 23 with conductive wires 22 inserted therethrough and a sleeve 24 disposed outside the conduit 23, a pressing and sealing device 25 is provided between the conduit 23 and the body 1, a plurality of conductive wires 22 are disposed within the conduit 23, each of the wires 22 is covered with an electrically insulative layer, the microphone 11 is connected with the circuit device via one of the conductive wires 22, the circuit device is connected with the receiver 12 via another one of the conductive wires 22, the sleeve 24 disposed outside the conduit 23 is movable on the conduit 23, and metal or nonmetal wires which are bendable and can maintain the bending deformation are provided within a wall of the sleeve 24.

According to the above descriptions, the conduit 23 is a single-lumen or multi-lumen structure which has a length ranging between 30 mm and 100 mm, an outside diameter ranging between 0.5 mm and 4 mm and a wall thickness of no more than 2 mm, and the transparent or non-transparent material thereof is one or more of soft high-molecular polymer silicone rubber Nusil Med 4930, polyurethane, TPU rubber, TPE, or a polymer of silicone rubber and polyurethane.

The length of the sleeve 24 is less than or equal to the length of the conduit 23, and the sleeve may be a radially enclosed or radially open circular or non-circular sleeve disposed on the conduit. The sleeve 24 has an outside diameter of between 1.0 mm and 8.0 mm and a wall thickness of no more than 2 mm. The sleeve 24 further comprises a circular, or oval, or polygonal blind hole that is closed at two ends. The blind hole has a diameter of no more than 6.0 mm, and a bendable metal or nonmetal wire e.g., a copper wire, a superelasticity memory alloy, or the like which is connected with no circuit and which can maintain the bending deformation are provided within the blind hole to function as the preformed ear hook. The metal or nonmetal wire may have a circular, oval, or polygonal cross section, with an outside diameter thereof not exceeding the diameter of the blind hole.

A pressing and sealing device 25 is provided at an end next to the body 1 of the hearing aid. The pressing and sealing device 25 is disposed outside the conduit 23, and the conduit 23 can slide within an inner hole of the pressing and sealing device 25. The pressing and sealing device 25 may be connected with the sleeve 24 fixedly or detachably. The pressing and sealing device 25 is connected with an opening on the top of the body 1 and is compressed and deformed radially. The inner wall of the deformed pressing and sealing device 25 compresses the conduit 23 directly or via the conduit 24 so that a large radial deformation is caused to the conduit 23. In this way, the conduit 23 and the conductive wires 22 within the conduit 23 are fixed together to prevent relative movement of the conduit 23 with respect to the opening of the body 1. The opening on the top of the body 1 may taper from the outside to the inside of the body 1 or the diameter of the opening may decrease stepwise. The pressing and sealing device 25 and the opening on the top of the body 1 may be connected with each other by being radially snap-fitted together, by being tightened together radially via pins, or by being deformed and pressed together due to radial interference, or the like. The pressing and sealing device 25 further functions to seal the opening on the top of the body to prevent penetration of water and humidity into the body 1. A typical form of the pressing and sealing device 25 is a cone made of a soft high-molecular material. An inner hole at the larger end of the cone closely mates with or is fixedly bonded with the outside surface of the sleeve. The smaller end of the cone can be inserted into the opening on the top of the body 1 to generate a large radial compression deformation so that the conduit 23 together with the conductive wires built therein are fixed tightly with the opening on the top of the body. Furthermore, the portion of the smaller end of the cone that is inserted into the body will recover to the original diameter thereof because it is not compressed and restricted, and the diameter is larger than that of the opening on the top of the body, so the cone can be prevented from sliding out of the opening on the top of the body. The material of the cone is one or more of silicone rubber Nusil Med 4930, polyurethane, TPU rubber, TPE, or a polymer of silicone rubber and polyurethane.

The other end of the conduit 23 is inserted into a fixed hard plastic shell in which the microphone 11 and the receiver 12 are disposed. A plurality of conductive wires 22 are connected with the microphone 11 and the receiver 12 respectively. The outside wall of the conduit 23 is fixedly connected with an opening of the sound device shell 13 so that the conduit 23 cannot move with respect to the sound device shell 13 to prevent the conduit 23 from being pulled out.

The size of the digital hearing aid of the present disclosure is changed mainly in two ways. One way is to adjust the bending degree, the shape and the size of the sleeve and the metal wires within the sleeve depending on the practical external physiological structure of the ear of the patient with hearing problems and then keep the shape and the size of the ear hook fixed. Bendable metal or nonmetal wires that can maintain the bending deformation are provided within a wall of the sleeve 24 so that the shape and the size of the ear hook can be adjusted and fixed for an unlimited number of times. A special space for receiving the inserted conduit is provided in the body 1, and the special space can prevent the push force for inserting the conduit 23 from being transferred to the electrical and mechanical connection between the end of each of the conductive wires 22 and the components such as the digital signal processor.

The other way to change the size of the hearing aid is to change the length of the hearing tube 15 and change the soft ear mold 16 that experiences a large radial deformation by use of detachable soft and hard shell structures depending on the size and the length of the auditory canal of the patient with hearing problems. A series of soft ear molds 16 with increasing diameters can be provided for choice depending on the size of the auditory canal of the patient with hearing problems so that the soft ear mold can be put on the hearing tube 15 conveniently. The interference fitting generated because the inside diameter of the fixed tube 18 of the soft ear mold 16 is less than the outside diameter of the hearing tube 15, the unsmooth surface with protruding grooves of the outside wall of the hearing tube 15, and a flange with a large diameter at the end of the hearing tube 15 can effectively prevent the soft ear mold 16 from sliding out of the hearing tube 15.

As shown in FIG. 5 to FIG. 8, the digital hearing aid of the present disclosure has a series of soft ear molds 16 of different sizes that are formed of a soft high-molecular material through a one-shot injection molding process. The soft ear mold is a conic structure with a flat head, and the tail thereof is formed to have no less than two large hemlines, and no less than one vent hole having a diameter of no more than 2 mm is formed on the hemlines. The material of the ear mold is one or more of silicone rubber Nusil Med 4930, polyurethane, TPU rubber, TPE, or a polymer of silicone rubber and polyurethane.

The digital hearing aid of the present disclosure is a general-purpose hearing aid that can be used for both the left ear and the right ear. The soft conduit 23 and the conductive wires 22 within the conduit 23 are of small diameters and can be bent and deformed easily so that they are adaptive to the shape of the auricle and the facial structure and conform to the different physiological structures between the auricle and the helix of the left ear and the right ear. Ear hooks of different shapes and sizes can be formed by manually bending the sleeve 24 and the metal wires within the sleeve 24 during the fitting of hearing aids so as to fit in with the different physiological structures of the left ear and the right ear between the helix and the back of the ear.

According to the hearing impairment degree of the patient with hearing problems and the audio frequency distribution characteristics, no less than two, preferably no less than five target hearing curve models are preloaded, and hearing aid fitting programs are formulated for the target hearing curve models respectively and then stored into the digital signal processor. When a patient wears the hearing aid, he/she can select a suitable target hearing compensation fitting program and a volume level by operating the button of the program shifter 8 and the volume button. Practical hearing impairment covers various situations, so it is possible that the preset target fitting programs are unsuitable for a small part of patients. Taking this into consideration, the hearing aid of the present disclosure is further provided with a programmer interface in addition to the general fitting programming function, so the practitioner can make personalized fitting programming for this small part of patients according to practical hearing curves of the patients and keep the preset target hearing curve models in an inactivate state.

The digital hearing aid of the present disclosure is further provided with a alarming light to remind the user of opening the battery cover or switch off the circuit to save energy when the hearing aid is not worn. Moreover, the alarming light makes it easier to find the hearing aid when it is lost. The operating principle of the alarming light is as follows: a color light is installed on a side surface of the body 1 and next to the volume button 10, a conductive wire 22 is connected to the light at one end, and after being connected with the flashing light device located inside the body 1, the conductive wire 22 is introduced out of the body 1 together with other conductive wires 1 via the conduit 23. Then, the conductive wire 22 is introduced into the sound transmitting device 2 and connected to a sensor that is fixed on the receiver. Next, the conductive wire 22 is introduced into the body 1 from the sensor via the conduit 23 to connect with the electrode of the battery 7 so as to form a complete closed circuit. The sensor is sensitive to temperature and acoustic wave or vibration, and under the temperature conditions in the auditory canal or when wave sound vibration is generated due to the operation of the receiver 12, the sensor switches off the circuit so that the light is turned off. When the hearing aid is taken out of the auditory canal and the user forgets to open the battery cover or to switch off the circuit, or after a preset time interval e.g., 30 s, the sensor switches on the circuit so that the light is turned on to flash so as to remind the user of opening the battery door or switching off the circuit. When the hearing aid is lost, i.e., the hearing aid is not worn by the user, the flashing light can help to find the hearing aid.

More importantly, the length of the conduit 23 of the digital hearing aid of the present disclosure is variable depending on the structure and size of the ear of the user. One way is to insert the conduit 23 into or pull the conduit 23 out of the body and then fix the conduit 23 by the pressing and sealing device 25 on the top of the body 1; another way is to wind the conduit 23 into or out of the sleeve 24 and fix the conduit 23; a further way is to insert the conduit 23 into or pull the conduit 23 out of the sound device shell 13 and fix the conduit 23; and yet another way is to wind the conduit 23 into a coil which is stretchable and retractable along a length direction.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A digital hearing aid, comprising a body hung behind an ear and a sound transmitting device for receiving and outputting sound that is placed within an auricle and extends into an external auditory canal, the body and the sound transmitting device being connected and fixed together via a connecting device, the connecting device being formed of a material and a structure which are bendable, extendable and capable of maintaining the bending deformation, the connecting device being preformed into a shape of an ear hook, the sound transmitting device comprising a sound device shell having a microphone and a receiver built therein,
wherein the connecting device comprises a conduit with conductive wires inserted therethrough and a sleeve disposed outside the conduit, and the length of the conduit can be varied by means of inserting the conduit into or pulling the conduit out of the body; winding the conduit into or out of the sleeve and fixing the conduit; inserting the conduit into or pulling the conduit out of the sound device shell and fixing the conduit; and winding the conduit into a coil which is stretchable and retractable along a length direction.

2. The digital hearing aid of claim 1, wherein the body is of a unitary or non-unitary structure, a receiving cavity and a battery chamber are provided within the body, a chip and a circuit device are installed within the receiving cavity, a battery cover is disposed correspondingly at an opening of the battery chamber, batteries are installed within the battery chamber, and a program shifter, a standby microphone or other circuit interfaces or programming line sockets and a volume button are provided on a side surface of the body, and wherein the program shifter is a program shifter having no less than one preset program or listening environment and compatible with manual selection and machine programming, the volume button is a rolling or rotary button for adjusting the volume manually, and the preset program is shifted via the program shifter or by pressing the volume button.

3. The digital hearing aid of claim 1, wherein the sound transmitting device further comprises a soft jacket which is open at one end, the sound device shell is disposed within the soft jacket, a hearing tube that can be bent arbitrarily is disposed to extend from a front end of the soft jacket, a soft ear mold is disposed fitted over the hearing tube, the other end of the soft jacket opposite to the hearing tube is provided with a pulling-out line, and the surface of the pulling-out line has a plurality of non-smooth nicks thereon or is roughened.

4. The digital hearing aid of claim 2, wherein one end of the conduit is connected with the circuit device within the body, and the other end of the conduit is connected with the microphone and the receiver.

5. The digital hearing aid of claim 2, wherein the body is in a streamlined form with the width and the thickness thereof increasing gradually from a small tip portion to a big bottom portion, and a wireless receiver and a wireless transmitter for frequency-shift FM, Bluetooth, or communications between the left ear and the right ear, flashing light devices, and wireless locating or measuring transducers are installed within the receiving cavity of the body.

6. The digital hearing aid of claim 5, wherein a front and a back outside surface of the body are formed with a plurality of linear or nonlinear shallow grooves.

7. The digital hearing aid of claim 3, wherein an edge of the opening of the soft jacket is crimped inwardly to form an envelope, the sound device shell is put into the soft jacket from the opening and encased by the envelope of the soft jacket, pins are provided to fix the sound device shell and the soft jacket together, and the soft jacket and the sound device shell are detachable or undetachable from each other.

8. The digital hearing aid of claim 4, wherein a pressing and sealing device is provided between one end of the conduit and the body, the other end of the conduit is connected with the sound device shell, a plurality of conductive wires are disposed within the conduit, each of the wires is covered with an electrically insulative layer, the microphone is connected with the circuit device via one of the conductive wires, the circuit device is connected with the receiver via another one of the conductive wires, the sleeve disposed outside the conduit is movable on the conduit, metal or nonmetal wires which are bendable and can maintain the bending deformation are provided within a wall of the sleeve, an end of the conduit outside the sleeve can be winded into a spiral shape, the length of the sleeve is less than or equal to the length of the conduit, and the sleeve is a radially enclosed or radially open circular or non-circular sleeve disposed on the conduit.

9. The digital hearing aid of claim 3, wherein the soft ear mold comprises a fixed tube and a mold head, the hearing tube is inserted and fixed into the fixed tube, the mold head is a hemline structure tapering from the bottom to the top and made of an elastic material, a vent hole is provided on a sidewall of the mold head, an end of the mold head is provided with an earwax protective screen and a sound outlet that communicate with the hearing tube, and the mold head is a one-piece or multi-piece hemline structure.

10. The digital hearing aid of claim 8, wherein at least one of the two ends of the conduit is provided with a reserved end, the reserved end is disposed within the body and fixed by a pressing and sealing device, and the reserved end may also be disposed within the sound device shell.
